(19) United States
(12) Patent Application Publication
(10) Pub. No.: US 2026/0048547 A1
(43) Pub. Date: Feb. 19, 2026

(54) 3D PRINTING SYSTEM

(71) Applicants: Friedrich-Alexander-Universität Erlangen-Nürnberg Körperschaft des öffentlichen Rechts, Erlangen (DE); Julius-Maximilians-Universität Würzburg Körperschaft des öffentlichen Rechts, Würzburg (DE)

(72) Inventors: Ruben Gerrit SCHEURING, Würzburg (DE); Jürgen GROLL, Eibelstadt (DE); Stefan SCHRÜFER, Erlangen (DE); Dirk Wolfram SCHUBERT, Eggolsheim (DE); Janik ALTENHÖFER, Nürnberg (DE); Alexander BJÖRK, Erlangen (DE)

(21) Appl. No.: 19/102,056

(22) PCT Filed: Aug. 10, 2023
(86) PCT No.: PCT/EP2023/072225

§ 371 Date: May 7, 2025

(30) Foreign Application Priority Data
Aug. 10, 2022 (DE) 10 2022 208 332.6

(51) Int. Cl. B29C 64/336; B29C 48/02; B29C 48/86; B29C 48/92; B29C 64/118; B29C 64/209; B29C 64/393; B33Y 40/00; B33Y 50/02

(52) U.S. Cl. CPC B29C 64/336; B29C 48/02; B29C 48/865; B29C 48/92; B29C 64/118; B29C 64/209; B29C 64/393; B33Y 40/00; B33Y 50/02; B29C 2948/92704; B29C 2948/92904

(57) ABSTRACT

A 3D printing system includes a first cartridge container for reversibly receiving a first cartridge which stores printing fluid for 3D printing, and a print head with an outflow opening. The 3D printing system further has a first fluid line, which connects the first cartridge container to the print head to supply printing fluid to the print head. In addition, the 3D printing system has a first temperature-control channel, which encases the first cartridge container and the first fluid line externally, and which is passed through, in the intended state of use, by a temperature-control medium.

The invention relates to a 3D printing system.

3D printing systems have their origin in the field of so-called “rapid prototyping”, i.e. the short-term creation of prototypes. 3D printing was and is usually associated with a process originally also known as “fused deposition modeling”, in which thermoplastic material, usually in the form of a “filament”, is melted and applied through a nozzle onto a substrate in lines and layers.

Rapid prototyping in general and 3D printing in particular also has potential for single-part production and small series, since—especially in the field of plastics processing—complex and cost-intensive tool making can be avoided. In addition, these processes can also be used to reproduce comparatively complex geometries, including those with cavities and a variety of undercuts.

However, 3D printing is also of particular interest for medical applications, by way of example implants and the like. In most cases, no thermoplastic materials (or only a few specific ones) are used for this purpose, but rather often hardening materials, originally for example biologically inert materials such as silicones but also water-based hydrogels, for example alginate and the like. A frequently used biologically active “bio-ink” (printing fluid) is based on gelatin and its derivatives (for example. methacrylized gelatin) and represents a cost-effective compromise between biocompatibility, printability by thermal gelation and crosslinkability by chemical modifications, by way of example. Recently, the focus has shifted from synthetic materials (for example. liquid silicones and hydrogels) to natural bio-materials. In particular, components of the extracellular matrix (for example collagens) are increasingly being used because they exhibit high bioactivity and can be gelled by temperature change, by way of example. In this context, the timing of the gelation and consequently the temperature control are essential and decisive for a good printing result, in order to enable the best possible printability, bonding of the printed layers and thus dimensional stability.

The object of the invention is to improve 3D printing using temperature-sensitive materials.

This object is achieved in accordance with the invention by a 3D-printing system having the features of claim 1. Advantageous and in some cases in their own right inventive embodiments and further developments of the invention are set out in the subordinate claims and the description below.

The 3D printing system in accordance with the invention has a first cartridge container for reversibly receiving a first cartridge, which stores printing fluid for a 3D print, a print head with an outflow opening and a first fluid line which connects the first cartridge container to the print head for supplying printing fluid to the print head. Furthermore, the 3D printing system has a first temperature control channel which encases the outside of the first cartridge container and is guided at least along the first fluid line and, in the intended application state, a temperature control medium flows through the first temperature control channel.

The cartridge container is preferably designed in such a manner that, in the intended application state, it encloses the cartridge on the outside around at least one section containing the printing fluid.

Printing fluid is understood here and below in particular as a material which, in the state during the preparation, preferably has at least in part a sufficiently low viscosity for transportation and application (in this case, in particular for printing) but (by means of external “triggering” or by itself) can also experience a significant increase in viscosity (or also a solidification). Due to the latter, the printing fluid can be used in order to create three-dimensional objects. In the state in which it can be conveyed, the printing fluid can be cross-linked, is part-cross-linked or is also cross-linked. The increase in viscosity can be achieved by solidification and/or cross-linking (gelling). Both single-phase and/or single-component materials and multi-component and/or multi-phase materials (which, by way of example, are only mixed during the printing process) are conceivable.

It is preferred that the first temperature control channel also encases the outside of first fluid line, in other words is arranged coaxially thereto. This advantageously produces a particularly good exchange of heat. Alternatively, the temperature control channel can, however, also “only” run next to the first fluid line, in particular at a smallest possible distance thereto, by way of example at less than 1 millimeter. Optionally, however, the temperature control channel in the region of the fluid line can also be divided into multiple sub-channels, which run along the first fluid line, next to it (and at a small distance of less than 1 millimeter, by way of example). By way of example, these sub-channels can also be spiraled around the first fluid line. The latter is useful, by way of example, when using pipes or hoses, when the first fluid line and the first temperature control channel are routed freely, or by additive manufacturing in the case of the first fluid line and the first temperature control channel being guided in a “connection block” or connection module between the first cartridge container and the print head.

Due to the above described arrangement and design of the temperature control channel, it is advantageously possible to continuously (at least almost) control the temperature of the printing fluid from the “tank”, i.e. the cartridge, up to the print head and consequently at least almost up to the outlet. “At least almost” is understood here and below as at least 70 preferably at least 80 percent of the entire length of the relevant channel or line. The first temperature control channel is expediently configured in such a manner that it at least encases the first cartridge container and is guided along the first fluid line over its entire length at least up to the print head or also in particular encases the first fluid line. This renders it possible in an advantageous manner to influence, in particular control, the solidification behavior of the printing fluid. By way of example, it is possible to prevent premature cooling and thus premature gelling—at least an increase in viscosity in excess of a conveyability limit—(in the relevant fluid line).

In a preferred embodiment, the first temperature control channel continues into the print head. The first temperature control channel advantageously encases at least in sections the outside of the first fluid channel for the printing fluid in the print head. As a result, a “temperature control length” (i.e. the length, along which the temperature of the printing fluid is controlled) can be customized to the length of the first fluid line and the first fluid channel and can consequently render it possible to continuously control the temperature. Fundamentally, it is also conceivable here that the first temperature control channel runs in the print head next to the first fluid channel therein i.e. is guided along this fluid channel.

In an expedient embodiment, the first temperature control channel merges into a first return line on the print head side—i.e. in the print head or at the end of the first fluid line upstream of the print head—(or optionally as described below only in the region of a print nozzle that can be reversibly coupled directly or indirectly to the print head). In particular, this first return line is guided at least in the region of the first fluid line coaxially with respect to the first temperature control channel (in particular on the outside thereof). This is preferably the case when the first temperature control channel encases the first fluid line and where appropriate also the first fluid channel. As a result, the first temperature control channel can be thermally isolated.

In an alternative embodiment, the first temperature control channel merges into a return pipe on the print head side. This return pipe is guided at least in the region of the first fluid line separately from the first fluid line. In particular, this return pipe is an independent hose line.

In a preferred embodiment, the 3D printing system has a temperature control device for setting the temperature of the temperature control medium. In particular, the temperature control device is configured so as to set a target temperature value in the temperature control medium at least on the inflow side and/or in the region of the first cartridge container. By virtue of the fact that the 3D printing system itself has this temperature control device, the 3D printing system is advantageously self-sufficient in this regard. In addition, it is comparatively simple to control the temperature control in this manner. It is preferred that the 3D printing system also has a controller which is configured so as to activate the temperature control device for setting a temperature value predetermined on the controller side-optionally in interaction with an operator.

In an optional embodiment, the temperature control device has a first heating and/or cooling element, in particular in the form of a Peltier element in the region of the first cartridge container. Peltier elements have the advantage that they can both heat and cool. Consequently, the temperature control device is comparatively flexible, in particular in the case of a comparatively small installation space. It is preferred in this case that the Peltier element is arranged in a section of the first temperature control channel surrounding the first cartridge container and is expediently coupled in a heat conducting manner thereto.

In an optional variant, the temperature control device has multiple heating and/or cooling elements, by means of which it is possible to predetermine a temperature curve within and along the temperature control channel. By way of example, Peltier elements are used in this case since these can be used locally and can provide both a heating function and a cooling function. Alternatively, it is also possible to use “classic” heating cartridges.

In a further expedient embodiment, the 3D printing system has a second cartridge container, a second fluid line and a second temperature control channel. These are preferably designed in a similar manner to the first cartridge container described above, the first fluid line and the first temperature control channel. In particular, the second cartridge container is therefore used for reversibly receiving a second cartridge, which stores printing fluid for the 3D print. The second fluid line connects the second cartridge container to the print head for supplying printing fluid to the print head. The second temperature control channel encases the second cartridge container and preferably also the outside of the second fluid line and, in the intended application state, a temperature control medium flows through the second temperature control channel. Optionally, the 3D printing system also has a third cartridge container, a third fluid line, a third temperature control channel etc. (or also a multiplicity, i.e. four or more).

The presence of the second (and where appropriate the third or further) cartridge containers etc. renders it possible to advantageously use a multi-component print, i.e. the print with different “inks” (i.e. printing fluids) optionally alternately or in succession without changing the system. In addition, the different printing fluids can also be used simultaneously, i.e. in particular mixed first in the print head. Furthermore, however, multiple cartridge containers also render possible a quasi-continuous operation in that the same printing fluid is used for at least two cartridge containers, but the cartridges are used alternately so that an empty cartridge can be exchanged while the other cartridge is being used. It is also possible to use multi-component systems for the printing fluid, wherein individual components of the multi-component system are filled, by way of example, in one respectively assigned cartridge and are mixed in the print head, by way of example.

In a preferred embodiment, the first and the second fluid line are brought together in the print head (in particular with their respective fluid channels) at the outflow opening. In other words, the respective fluid channels issue via the outflow opening into the environment or in to a print nozzle that can be coupled optionally downstream and in particular in a reversible manner.

Optionally, the 3D printing system has more than two (by way of example at least three) cartridge containers and assigned fluid lines and temperature control channels which are preferably designed in the same manner as those described above. It is preferred that these multiple fluid lines are likewise brought together in the print head (in particular with their respective fluid channels) at the outflow opening.

In an advantageous embodiment, the print head has an additional supply for the temperature control medium, by way of example a separate temperature control line (i.e. in particular in addition to the respective temperature control channel described above), by means of which, in the intended operation, the temperature control medium is preferably supplied at a different temperature value in comparison to the cartridge container, and/or an additional heating and/or cooling element (in particular in the Peltier element). As a result, it is possible to predetermine a temperature value locally at the print head in a comparatively flexible manner and independently of the first or second temperature control channel. It is preferred that the additional supply for the temperature control medium (i.e. the separate temperature control line) is connected for this purpose locally to the print head to a corresponding (in particular further) temperature control channel.

In an optional embodiment, the possible multiple (two or more) temperature control channels are brought together in the print head so as to form a mixing temperature and surround in particular the fluid lines that have been brought together. Subsequently, the temperature control channels which have been brought together merge into a common return pipe (or the coaxial return line described above). Alternatively, however, each individual temperature control channel can also have a separately assigned return pipe or a coaxial return line in order to purposefully prevent such a mixing temperature from forming. However, in the case of more than two temperature control channels, it is also possible to the same extent to guide multiple temperature control channels to a common return pipe (or return line).

In an expedient embodiment, the 3D printing system has the above mentioned print nozzle which, at least in the intended application state, is reversibly, and optionally directly or indirectly, connected to the outflow opening. A nozzle channel for the printing fluid passes through this print nozzle and, in the intended application state, the printing fluid flows through the nozzle channel. Optionally, the 3D printing system has multiple print nozzles which have a different nozzle channel cross-section and consequently can be used for different printing tasks. It is preferred that the nozzle channel is enclosed at least in sections coaxially by a channel for the temperature control medium. It is further preferred that the print nozzle is constructed in a triaxial manner and consequently has two channels which surround the (in particular central) nozzle channel respectively in a shell-like or coaxial manner and render it possible to supply and return the temperature control medium. In an optional embodiment, these channels, in particular in the intended connected state, are preferably connected to the temperature control channel—in particular at its section formed in the print head—and consequently are supplied from the print head with temperature control medium (inflow and return flow).

For reversibly coupling the print nozzle to the print head, both expediently have mutually corresponding coupling means. These can create a magnetic, preferably electromagnetic coupling by way of example. However, the coupling means expediently jointly form a type of bayonet connection, in that a groove with an undercut is arranged on the print head or the print nozzle and a corresponding pin (by way of example with a mushroom head) is arranged on the print nozzle or on the print head. By way of example, the groove is in the shape of a section of an arc, (by way of example a quarter circle). In this case, the print nozzle is placed against the print head (the pin, preferably two pins, are inserted into a corresponding opening of a respectively assigned groove) and by a corresponding rotation against the print head is fixed thereto.

In a further expedient embodiment, the print nozzle has a closing valve for the nozzle channel. This allows for particularly precise printing, since the entire fluid flow through the 3D printing system does not need to be stopped, but only the fluid flow on the outlet side.

Optionally, a mixing channel or also “homogenizing channel” is formed in the print head or also in the print nozzle, by way of example as a type of static mixing unit. Optionally, such a “mixing unit” (i.e. such a channel) can also be formed in a separate component which can be interpositioned between the print head and the print nozzle, by way of example. As a result, it is possible to homogenize the (entire) printing fluid upstream of the outlet—in particular when multiple fluids stored in respective separate cartridges are mixed together.

In an optional, expedient embodiment, the 3D printing system has at least one additional module (or also intermediate module) which is interpositioned or can be interpositioned between the aforementioned print nozzle and the print head (i.e. in a specific application state, preferably in a task-specific application configuration of the 3D printing system). By way of example, this additional module forms the aforementioned separate component. This or the respective additional module has coupling means on one side facing the print head and on one side facing the print nozzle (i.e. on both sides), and in an expedient manner the coupling means are coupling means which are arranged complementary to the coupling means arranged on the print nozzle or the print head respectively. The additional module also has a fluid channel which, in the intended application state, renders it possible to convey the printing fluid from the print head into the nozzle channel of the print nozzle. For the case that the print nozzle also has a temperature control channel, such a temperature control channel is also formed in the additional module in order to render it possible to convey the temperature control medium to and from the print nozzle. Optionally, the additional module also has electrical contact elements which render possible an electronic connection (by way of example for supplying current and/or exchanging data) between the print head and print nozzle and/or between the print head and electronic components of the additional module. The print head has in an expedient manner corresponding (counter) contact elements. By way of example, the additional module has a sensor (for example a temperature sensor or pressure sensor or for measuring the electrical resistance), which can be connected by means of such an electronic connection to the controller of the 3D printing system.

Furthermore, the additional module optionally has one or more “insertion shafts”(by way of example a sensor bore hole, a milled-out pocket or the like) into which a sensor, a heating element, a cooling element or the like can be inserted depending on the requirement, in order to be able to record process variables of the printing fluid and/or of the temperature control medium and/or in addition to influence the latter (by way of example control its temperature). Furthermore, it is also possible to insert into such an insertion shaft a sensor system for recording the surroundings and/or the substrate, by way of example a camera, a LIDAR sensor, a confocal laser, an ultrasound sensor or the like.

Optionally, it is also possible for such an insertion shaft to penetrate into the fluid channel so that printing fluid flows around and/or through an element inserted therein. In this variant, the (respective) temperature control channel is preferably guided around this insertion shaft. By way of example, such an insertion shaft can receive at least one sensor (by way of example for measuring pressure, temperature, pH or electrical resistance), a “lab-on-a-chip”, a mixing unit (by way of example a static mixing unit or the like) or an additional material inflow for a further component for the pressure fluid.

The print nozzle can also optionally have an insertion shaft of the type described above. By way of example, it is possible to insert into such an insertion shaft, which does not penetrate into the fluid channel, an (in particular unilateral) force sensor, by means of which it is possible to record forces which act (laterally or axially) on the print nozzle. The recorded forces are expediently used in the controller to detect collisions of the print nozzle, for example, with the substrate or the like, for measuring surfaces by contact (in particular in the manner of a coordinate measuring device or the like) or for determining a dimension (in particular an angle) of a deflection of the print nozzle, in particular a needle-like nozzle tip. It is advantageously possible for application cases in which during a printing process the print nozzle is submerged in a viscose medium and prints therein to use the determination of the deflection of the print nozzle (also: nozzle bending) so as to position the print nozzle as precisely as possible at a target coordinate, irrespective of a possible deflection of the print nozzle. By way of example, the deflection can be considered as a type of offset. It is fundamentally also possible here to use various nozzle tips (i.e. with different lengths and/or diameters) for different print processes, so that a respective different bending behavior is present. Moreover, it is possible to insert into such an insertion shaft of the print nozzle a separately controllable temperature controller (for example a heating element, Peltier element etc.) with an assigned temperature sensor in order in addition to render it possible to provide temperature zones in the 3D printing system.

In an expedient development, the respective additional module and/or the print nozzle also have an identification element for the automated identification. This is, by way of example, a microchip, an RFID tag or NFC tag, a marking for visual identification (by way of example a bar code or QR code). The information stored in such an identification element includes, in particular, the type of print nozzle or additional module, preferably a design and optionally also a sensor configuration, provided that this is achieved, for example, in fixedly predetermined additional modules or print nozzles. It is preferred that the 3D printing system also has means for reading out the corresponding identification element (by way of example an interface for wireless communication or a code scanner). Based on the information read in from the additional module or the print nozzle, software features specified in the controller of the 3D printing system are activated, by way of example. Optionally, an RFID tag or NFC tag can also be used for the localization of the print nozzle in the three-dimensional space.

It is also preferred that each fluid line, in particular upstream of the inflow into the print head or also in the print head itself, is assigned in each case a (preferably controllable) valve. As a consequence, it is possible, by way of example, when a cartridge is being exchanged to avoid printing fluid flowing from other fluid lines into the “empty” fluid line.

In an expedient embodiment, the 3D printing system has the above described controller and at least one temperature sensor which is connected to the controller. The controller is configured, in particular, so as to activate the temperature control device in dependence upon a temperature value recorded by means of the temperature sensor or the respective temperature sensor. By way of example, the controller is configured so as to regulate the temperature control medium with the aid of the recorded temperature value (actual value) to a predetermined temperature value (set value).

It is preferred that the 3D printing system also has a pump which is configured so as to convey the temperature control medium.

In an expedient embodiment, the first or second (or each further) cartridge container is configured so as to receive a conventional syringe as a cartridge and to couple it to the first or second fluid line. Volumes between 3 and 55 ml are preferably used as usual injection volumes. In the case of cartridge containers which are accordingly customized, it is possible to use for special applications, by way of example for comparatively large “print applications” (printing larger tissue models, organs (for example livers) and/or for supporting structures, accordingly larger syringes which have, by way of example, a volume between 180 and 960 ml. Alternatively, the cartridge can also represent a special tank for the printing fluid, by way of example comparable with a “tank module” of an inkjet printer.

At least in the case of the syringe as a cartridge, the 3D printing system also has a pump apparatus which is used to operate the cartridge, in particular therefore the syringe, so as to dispense the fluid when the operation is running. In the case of the syringe, this can be achieved by a type of syringe pump. It is likewise possible to also use here hydraulic-or pneumatic-actuated pump apparatuses.

In a further expedient embodiment, the 3D printing system has a (in particular in each case one) valve which is configured so as to vary a through-flow between a section of the first or second temperature control channel surrounding the first or second cartridge container and a section surrounding the first or second fluid line. In particular, it is possible in this manner to control the flow rate by the temperature control medium and/or also the dwell duration of the temperature control medium in the respect section.

In a preferred embodiment, the first or section fluid line and the section of the first or second temperature control channel accordingly assigned thereto are designed in a flexible manner (“hose line”). Since a multiplicity of the above mentioned “bio-inks” has photosensitive constituents, the relevant fluid line and/or the assigned temperature control channel is expediently designed to be non-transparent. Alternatively, in order to be able to use light-insensitive printing fluids, the relevant fluid line or the temperature control channel can also be designed transparent.

In an optional embodiment, at least one optical window (i.e. an area that is permeable to radiation) is arranged upstream of the outflow opening (by way of example in the print head or even in the relevant fluid line itself) or in the print nozzle and the printing fluid can be exposed to radiation through the optical window. It is preferred that the (or the respective) optical window is designed for connecting fiber optics so as to supply the radiation. By way of example, this renders it possible by means of IR or UV radiation to achieve a so-called photocrosslinking, i.e. a light-induced crosslinking in order to render it possible to purposefully use a pregelation in particular so as to increase viscosity. The pregelation can promote form stability of the print image (i.e. of the object to be printed).

Optionally, the optical window (or at least one of possible multiple optical windows) is arranged at a smallest possible distance with respect to the (outflow-side) nozzle opening. This is particularly expedient when a rapid reaction of the printing fluid to the radiation is to be expected.

In a further expedient embodiment, diametrically opposed coupling means are arranged on the print head on two opposite sides, preferably flat sides, at a comparatively small distance from each other, so that multiple print heads can be coupled to one another in series. As a result, this renders possible simultaneous area printing using multiple print heads, which is particularly advantageous in the case of rapidly reacting printing fluids and/or large area “print images” (objects with a comparatively large area cross-section, by way of example of more than 5 to 10 centimeters.

Accordingly, the 3D printing system also has more than one of the above described print heads which are each connected by means of a fluid line to at least one assigned first (where appropriate also a second) cartridge container and a correspondingly assigned temperature control channel. In other words, more than one of the above described 3D printing systems are provided and in each case form a “subsystem”, which in turn are coupled to one another by means of the print heads and as a result form a type of “print head strip” so that it is possible to print an area rapidly.

It is preferred that the 3D printing system also has a wide-slot nozzle which, in the intended application state, is connected downstream of the multiple print nozzles that are mutually coupled to the pressure head strip. This means that not only multiple comparatively thin strands (filaments; without this wide-slot nozzle) but also a comparatively wide (by way of example multiple centimeters, by way of example 3 to 15 centimeter) band can be printed.

In a further expedient embodiment, the 3D printing system has a controller (preferably the above described controller) and at least one pressure sensor connected to the controller. The pressure sensor is arranged in such a manner that, in the intended operational state, it is in contact with the print fluid. The pressure sensor is expediently arranged in the print head or in the print nozzle. In addition or as an alternative to the above described activation of the temperature control device—the controller is especially configured and provided so as to actuate the above described pump apparatus in dependence upon a pressure value recorded by means of the pressure sensor so as to convey the printing fluid, preferably to control (in particular in terms of a “closed loop” control). In an expedient manner, the 3D printing system has multiple pressure sensors in order by way of example to detect a pressure difference between the respective cartridge and the print nozzle (and/or before different printing fluids or components of the printing fluid are mixed) and preferably also so as to be able to use this information for the closed loop control.

The above described invention renders it advantageously possible—in particular for the case that in addition the Peltier elements (which can be used both for heating and for cooling) are provided—to provide temperature profiles at least in sections along the length of the temperature control channel. By way of example, it is possible in this manner to achieve a “pregelation” of the printing fluid (by way of example by locally increasing or reducing the temperature) upstream of its outflow from the print head or the nozzle opening.

The conjunction “and/or” is to be understood here and below in particular to mean that the features linked by means of this conjunction can be designed both identical and also as alternatives to one another.

Exemplary embodiments of the invention are explained in detail below with reference to a drawing. In the drawing:

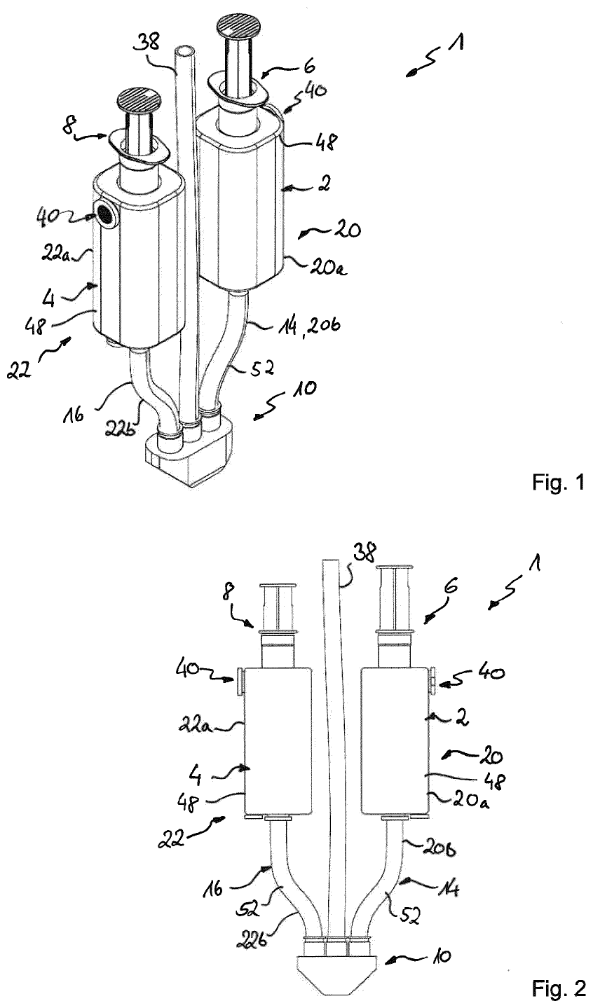

FIG. 1 shows schematically a 3D printing system in a detailed perspective view,

FIG. 2 shows the 3D printing system in a lateral view,

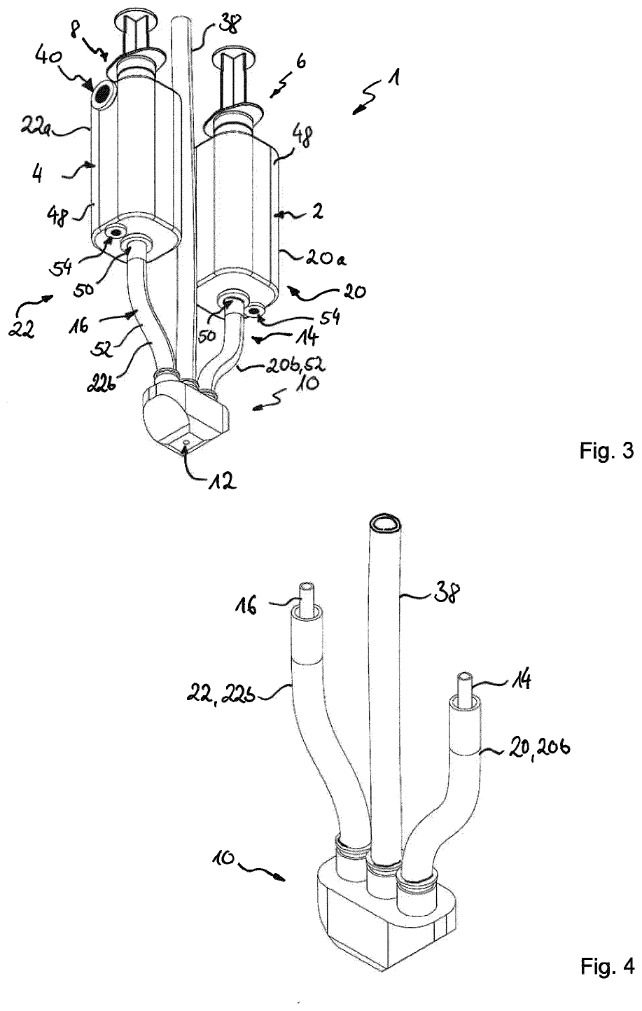

FIG. 3 shows schematically the 3D printing system in a perspective view with a view of an underside,

FIG. 4 shows schematically the 3D printing system in a partially disassembled state in a perspective view,

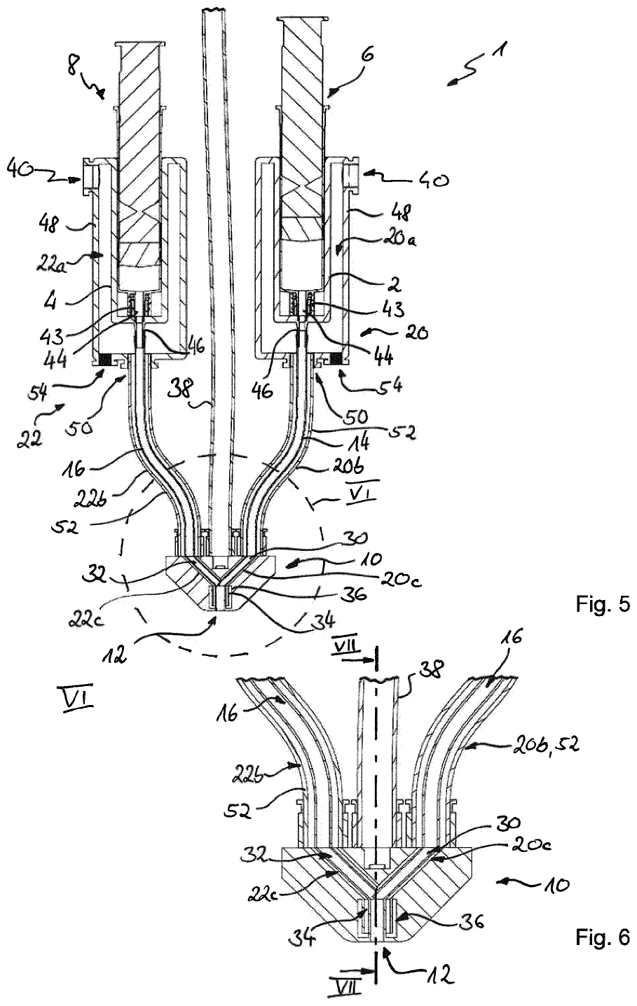

FIG. 5 shows the 3D printing system in a schematic sectional representation,

FIG. 6 shows schematically the 3D printing system in a detailed view VI according to FIGS. 5,

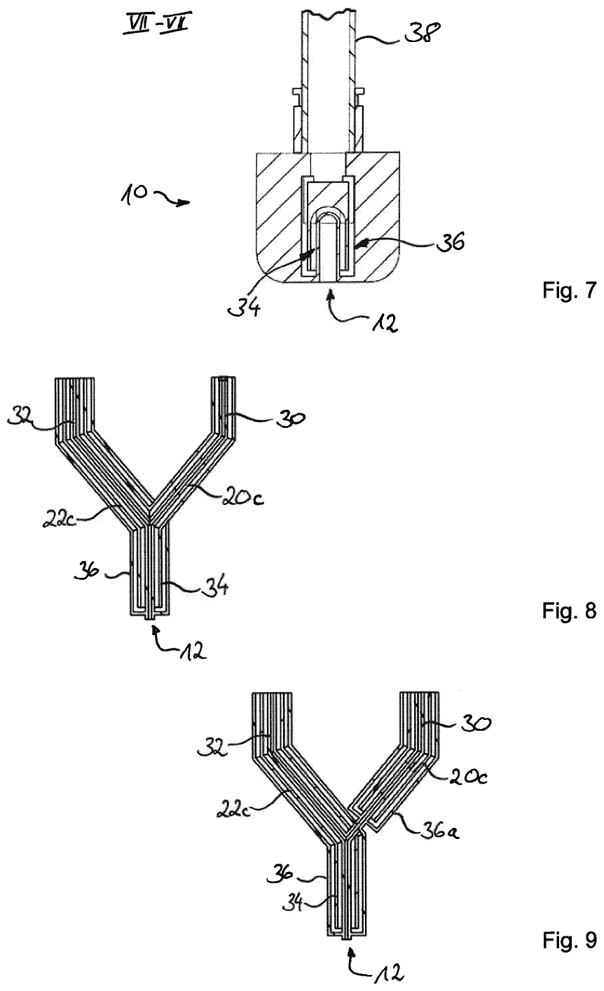

FIG. 7 shows schematically the 3D printing system in a sectional view VII-VII according to FIGS. 6,

FIGS. 8-12 each show in a schematic sectional view various exemplary embodiments for a channel path within a print head of the 3D printing system.

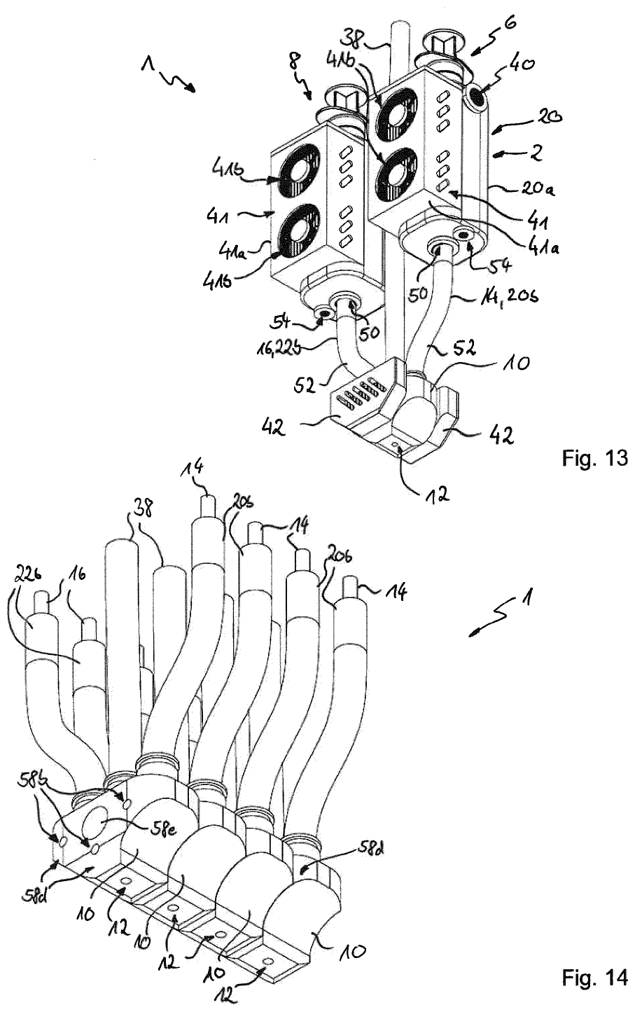

FIG. 13 shows schematically a further exemplary embodiment of the 3D printing system in a perspective view with a view of an underside,

FIG. 14 also shows schematically a further exemplary embodiment of the 3D printing system in a view according to FIGS. 13,

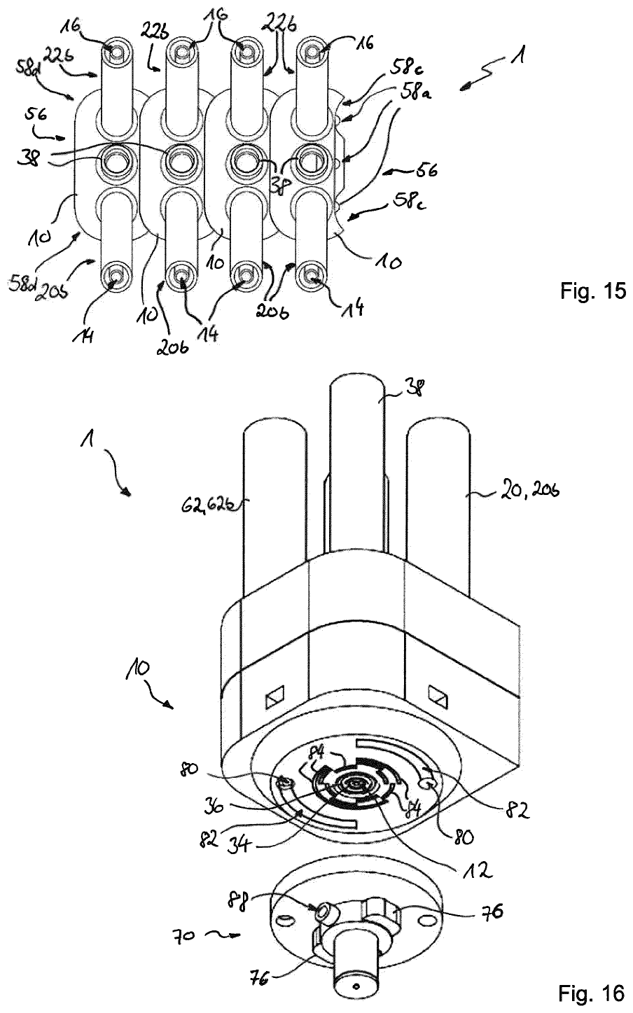

FIG. 15 shows schematically in a view from above the 3D printing system according to FIGS. 14,

FIG. 16 shows schematically in a perspective view a further exemplary embodiment of the 3D printing system with a view of an underside in a partially disassembled state,

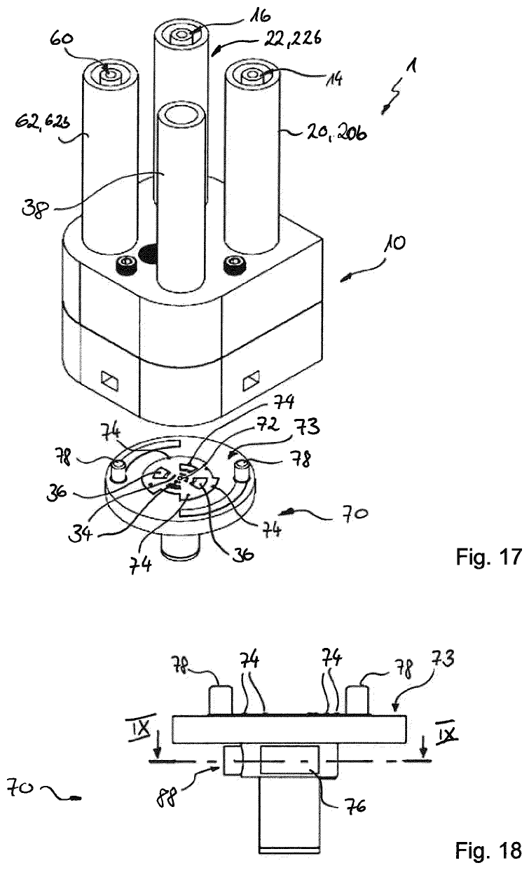

FIG. 17 shows schematically in a view according to FIG. 1 the 3D printing system according to FIG. 16,

FIG. 18 shows schematically in a lateral view a print nozzle of the 3D printing system according to FIG. 16 in a detailed representation,

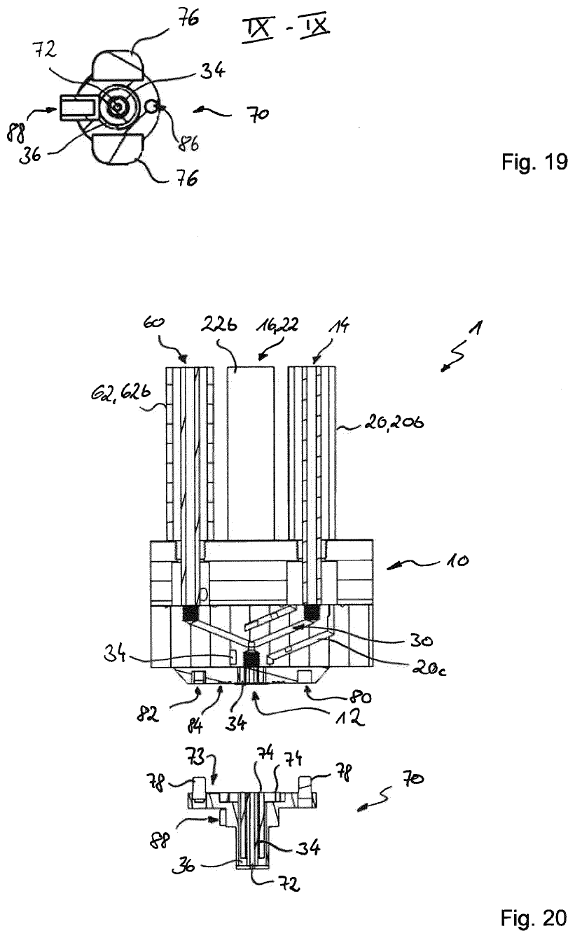

FIG. 19 shows schematically the print nozzle in a lateral view IX-IX according to FIGS. 18,

FIG. 20 shows the 3D printing system according to FIG. 16 in a schematic sectional view, and

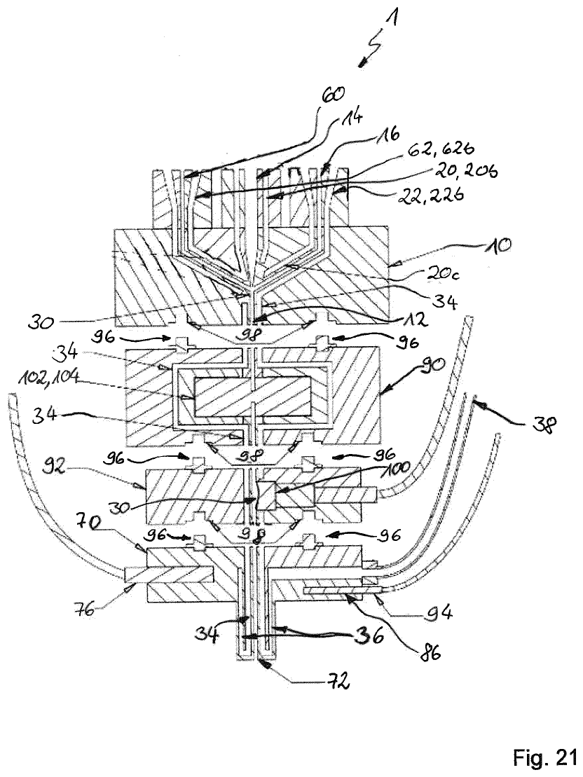

FIG. 21 shows a further exemplary embodiment of the 3D printing system in a view according to FIGS. 20,

Mutually corresponding parts are provided in all the figures with identical reference numerals.

FIG. 1 illustrates a section of a 3D printing system 1. In the illustrated exemplary embodiment, the 3D printing system 1 is configured so as to process so-called “bio-inks” as a printing fluid. These bio-inks are a biological active material—by way of example cells in an extra-cellular matrix or the like—which is used for so-called “tissue engineering”, i.e. for the artificial creation of body tissue or body-like tissue. By way of example, the bio-ink of the present exemplary embodiment is based on collagen. Nevertheless, other materials, by way of example silicone or similar, can be processed (printed) by means of the 3D printing system 1 described here and below in detail. When processing bio-ink in 3D printing, it is necessary to control the temperature in order on the one hand to prevent premature gelation of the bio-ink (i.e. before it is printed) but on the other hand also to enable gelation as quickly as possible after printing, in order to achieve the desired dimensional accuracy of the object to be printed.

For this purpose, in the present exemplary embodiment, the 3D printing system 1 has a first cartridge container 2 and a second cartridge container 4 which are each configured so as to reversibly receive a first cartridge 6 or a second cartridge 8 respectively. The cartridges 6, 8 are designed in the form of syringes and store the bio-ink for the 3D print. The 3D printing system 1 has a print head 10 with an outflow opening 12 (see FIG. 3) for printing with the bio-ink. Each cartridge container 2, 4 is assigned a corresponding first or second fluid line 14, 16 which connects the respective cartridge container 2, 4 to the print head 10 so as to supply the bio-ink to the print head 10. In order to control the temperature of the bio-ink, the 3D printing system 1 has a first temperature control channel 20, which encases the outside of the first cartridge container 2 (with a container section 20a) and the first fluid line 14 (with a line section 20b) and, in the intended application state, a temperature control medium flows through the temperature control channel. The 3D printing system 1 also has a second temperature control channel 22, which in a similar manner surrounds the second cartridge container 4 (with a container section 22a) and the second fluid line 16 (with a line section 22b). The arrangement of the two temperature control channels 20 and 22 is apparent from the sectional representation in FIGS. 4 and 5. The fluid lines 14 and 16 are thus designed together with the respective temperature control channel 20 and 22 surrounding them as a coaxial line.

In the case of a multi-component print, both cartridges 6 and 8 store different bio-inks. Optionally, both cartridges 6 and 8 also store components for the actual bio-ink, which are only mixed in the print head 10 (however, even in this case and below, the respective stored printing fluid is also referred to as a bio-ink).

As is particularly apparent in FIGS. 5 and 6, the first and the second temperature control channel 20, 22 continue into the print head 10 as a “head section” 20c or 22c respectively. The first and second fluid line 14, 16 continue in the form of a first or second fluid channel 30, 32 respectively for the bio-ink in the print head 10 and are encased at least in sections on the outside by the relevant assigned head section 20c, 22c. The two fluid channels 30 and 32 are brought together in the print head 10 and jointly issue in the outflow opening 12. The two head sections 20c and 22c are likewise brought together (united) in the print head 10 and form a sheathed line 34 which surrounds the united fluid lines 20, 22 almost up to the outflow opening 12 (i.e. apart from a residual wall thickness of the print head 10 that is necessary for manufacturing reasons) (see FIGS. 5, 6). As a result, it is possible to continuously control the temperature of the bio-ink (apart from a negligible residual path, namely the residual wall thickness).

So that the temperature control medium not only surrounds the cartridges 6, 8, the fluid lines 14, 16 and the fluid channels 30, 32 but can also flow around them, the sheathed line 34 merges via a U-shaped deflection channel 36 into a return pipe 38 that is connected to the print head 10. The return pipe 38 is in turn connected to a pump reservoir (by way of example a tank), not further illustrated.

From there, the temperature control medium is supplied in turn to the two temperature control channels 20, 22 in the upper region of the cartridge containers 2, 4 by means of a pump, not illustrated, via in each case an inflow 40.

FIGS. 8 to 12 illustrate schematically further exemplary embodiments for guiding the temperature control channels 20, 22 within the print head 10. According to FIG. 8—which illustrates a slight variation of the above described exemplary embodiment—the diversion channel 36 runs coaxially with respect to the head section 22c of the second temperature control channel 22 (and consequently also to the fluid channel 32). In this case, the return pipe 38 also runs outside the print head 10 as a return line coaxially with respect to the line section 22b. In this case, a mixing temperature is set in the sheathed line 34 in a known manner from the two temperatures selected for the first and second temperature control channels 20 or 22. Moreover, it is possible by also coaxially guiding the return pipe 38 to one of the temperature control channels 20 or 22, in this case specifically to the line section 22b, to enhance thermal isolation of the relevant temperature control channel 20 or 22 and also the corresponding fluid line 14 or 16.

According to FIG. 9, the two temperature control channels 20 and 22 do not unite in the sheathed line 34. On the contrary, the first temperature control channel 20, specifically its head section 20c merges into a diversion channel 36a which is returned coaxially as a return line. In contrast, the second temperature control channel 22 with its head section 22c forms the sheathed line 34 and the diversion channel 36 which is returned coaxially as in FIG. 8. The advantage lies herein that two printing fluids that are to be temperature-controlled independently of each other can also be temperature-controlled in the mixed state only by means of one of the temperature control channels 20 or 22 (in this case by means of the second temperature control channel 22).

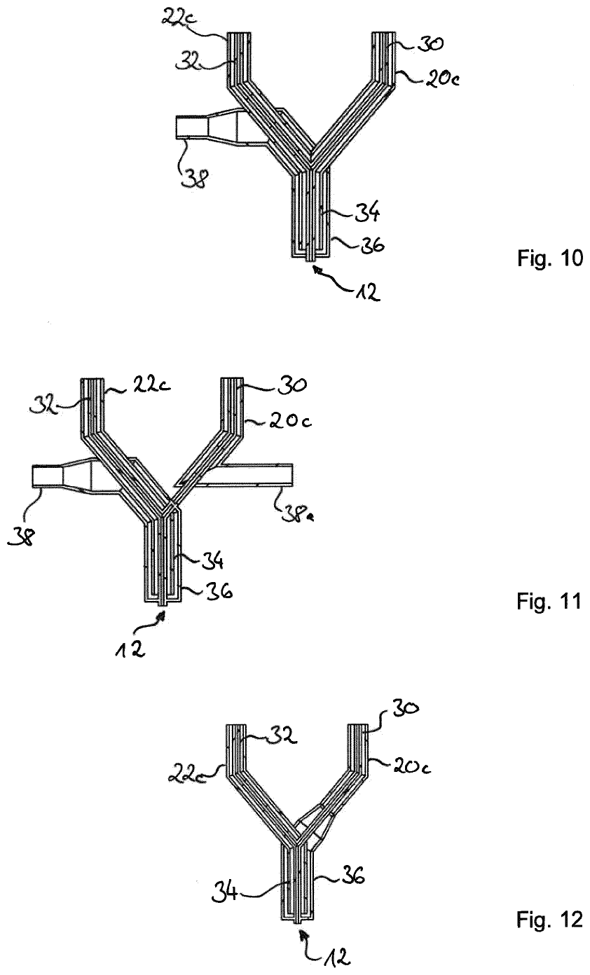

FIG. 10 illustrates a further geometric variation of the exemplary embodiment according to FIGS. 5 and 6. In this case, the return pipe 38 is guided laterally out of the print head 10.

FIG. 11 illustrates a geometric variation and a mixed shape of the exemplary embodiments according to FIGS. 9 and 10. However, in this case, the first temperature control line 20 does not merge into the diversion channel 36a but rather into a non-coaxially guided, laterally branching return pipe 38a.

FIG. 12 illustrates a further alternative exemplary embodiment. In this case, the “inflow” in the form of the second temperature control channel 22 merges via the diversion channel 36 into the first temperature control channel 20 which is consequently formed by the return pipe for the second temperature control channel 22. This is advantageous, by way of example, for cases in which the printing fluid (the relevant bio-ink) flowing through the first fluid line 14 requires a lower temperature than the printing fluid flowing through the second fluid line 16.

In the illustrated exemplary embodiment, the temperature control medium is temperature controlled, i.e. the temperature value of the temperature control medium is set, by means of a temperature control device of the 3D printing system 1 (not illustrated). This temperature control device has in the region of the first and second cartridge container 2, 4 respectively a first or second heating and/or cooling element, in this case specifically in each case a Peltier element 41 (illustrated by way of example in FIG. 13, incl. a housing 41a with a fan 41b arranged therein). The respective Peltier element 41 is arranged on the section of the relevant temperature control channel 20, 22 which surrounds the respective cartridge container 2, 4 (and preferably protrudes into it in a fluid-sealed manner).

In the exemplary embodiment illustrated in FIG. 13, two further Peltier elements 42 are arranged on the print head 10. Fans that may be present are not illustrated in this case. These Peltier elements 42 are used for the local temperature control within the print head 10, by way of example in the region of the mixed printing fluids.

Alternatively (or also additionally) the temperature of the temperature control medium is controlled in the above mentioned pump reservoir. For the case that the temperature is only controlled within the pump reservoir or also only in the region of the cartridge containers 2, 4, a drop in temperature occurs along the fluid lines 14, 16. The additional temperature control by means of the Peltier elements 41 and/or 42 and be advantageous to the extent that it is only necessary to supply energy locally by means of the respective Peltier element 41 or 42. In addition, the relevant Peltier element 41 or 42 can also be used for the (local) cooling.

In FIG. 5, the construction of the cartridge containers 2 and 4 with the respective surrounding temperature control channels 20 or 22 is apparent in the illustrated sectional representation. Accordingly, the respective cartridge container 2 or 4 forms a receiving shaft for the relevant cartridge 6 or 8 (in this case i.e. the relevant syringe). A collar 43 is formed on the base side in the cartridge containers 2 and 4 respectively and is used for receiving and coupling to a nozzle 44 of the cartridge (syringe, in particular according to the Luer-Lock principle). A hose connector 46 is formed opposite to this collar 43 on the outside of the respective cartridge container 2 or 4 (and consequently within the respective temperature control channel 20 or 22) and, in the intended assembled state (cf. FIG. 4), a hose which forms the respective fluid line 14 or 16 is plugged onto this hose connector.

The container sections 20a or 22a are formed by an outer wall 48, which surrounds the respective cartridge container 2 or 4 as a type of double wall, and consequently by the intermediate space between the cartridge container 2 or 4 and the outer wall 48. A connection opening 50 is provided in the outer wall 48 flush with the hose connector 46. The fluid lines 14 or 16 are guided through this connection opening. The line sections 20b and 22b are formed by a hose 52 which coaxially surrounds the fluid lines 14 or 16. This hose 52 is fastened (i.e. in the intended application state) in the connection opening 50 and terminates therein. As a result, the temperature control medium can flow from the respective inflow 40 into the container section 20a or 22a and from there through the connection opening 50 into the relevant line section 20b or 22b without in so doing the temperature control medium coming into contact with the respective bio-ink (or the printing fluid).

Furthermore, a further opening 54 is provided in the outer wall 48. This can be used for emptying the respective temperature control channel 20 or 22 for supplying further temperature control medium or for introducing a sensor, by way of example a temperature sensor or a pressure sensor.

FIGS. 14 and 15 illustrate a further exemplary embodiment of the 3D printing system 1. This has multiple (in this case four illustrated) print heads 10 which are designed comparable to the exemplary embodiment according to FIGS. 1 and each have two cartridge containers 2 or 4 (not further illustrated) coupled thereto. The print heads 10 are coupled in series to one another. For this purpose, the print heads 10 have coupling means which are arranged on corresponding opposite-lying flat sides 56 and are designed in this case by way of example in the form of positioning nipples 58a and complementary positioning depressions 58b, concave and convex flanks 58c or 58d and retaining magnets 58e. As a result, it is possible to form a “print head strip” which renders it possible to achieve a comparatively rapid area print.

In an exemplary embodiment, not illustrated, the 3D printing system also has a wide-slot nozzle which is connected to the print heads 10 coupled to the print head strip and thus renders it possible to print a wide band and not only individual filaments.

FIGS. 16 and 17 illustrate a further exemplary embodiment of the print head 10. This has three connections for the first and the second fluid line 14, 16 with a respectively assigned temperature control channel 20, 22 (line section 20b, 22b) and for a third fluid line 60 to an assigned third temperature control channel 62 (line section 62b). The total three fluid lines 14, 16 and 60 and the three temperature control channels 20, 22 and 62 run together in a comparable manner as described above (cf. sectional representation in FIG. 20).

Furthermore, the 3D printing system 1 comprises in this exemplary embodiment a print nozzle 70 which can be reversibly connected to the print head 10. In this case, the sheathed line 34 and the diversion channel 36 are not connected to each other within the print head 10 but rather are open on the base side and consequently issue into corresponding channels (labeled identically in FIG. 20) of the print nozzle 70. The sheathed line 34 and diversion channel 36 surround a nozzle channel 72 and the bio-ink is applied through the latter. On a connection surface 73 facing the print head 10, the print nozzle 70 has multiple electrical contacts 74 (here contact pins) for coupling to the print head 10 in terms of signal transmission and it is possible by means of these electrical contacts to connect by way of example sensors (by way of example temperature and/or pressure sensors, not illustrated) or heating elements 76 of the print nozzle 70.

The print nozzle 70 is configured for connection to the print head 10 by means of a type of bayonet connection. For this purpose, the print nozzle 70 has two pins 78 which are inserted into a corresponding bore hole 80 and interlock in a positive-locking manner by virtue of an approx. quarter rotation in a groove 82 in a manner not illustrated in detail. The counter contacts corresponding to the contact 74 are therefore formed by metal circular line segments 84 (see FIG. 16).

In addition to the heating element 76, the print nozzle 70 also has a sensor bore hole 86, into which optionally a temperature sensor or also a pressure sensor can be inserted and can be connected via the contacts 74 to an evaluation unit.

Furthermore, the print nozzle also has an optical window 88. This is used to connect a light-guiding element, for example fiber optics, by means of which the bio-ink flowing through the nozzle channel 72 can be optically treated, for example using UV radiation, in particular pre-gelled (“photocrosslinking”).

The 3D printing system 1 has in addition a controller (not illustrated) which is configured so as to activate the temperature control device for controlling the temperature of the temperature control medium. The temperature sensor or the possible multiple temperature sensors mentioned above (and where appropriate the heating elements 75 of the print nozzle 70) are connected to the controller in order to render it possible to precisely control the temperature control, in particular in a closed-loop manner. Optionally, the controller is also configured so as to open-loop control or closed-loop control the conveying of the respective printing fluid and for this purpose is connected to at least one corresponding pressure sensor (see description above).

FIG. 21 illustrates a further exemplary embodiment of the 3D printing system 1 which forms a development of the exemplary embodiments according to FIG. 16 to 20. In addition to the print nozzle 70, multiple intermediate modules 90 and 92 are provided here which can be coupled optionally between the print nozzle 70 and the print head 10. In the illustrated embodiment, the diversion channel 36 already in the print nozzle 70 issues into the return pipe 38 which is guided here connected by a hose outside the intermediate modules 90, 92 and the print head 10.

The print nozzle 70 has here a heating element 76 and a temperature sensor 94 which is inserted into the sensor bore hole 86 (provided here in the side). As an alternative to the above described bayonet connection, the print nozzle 70 has as a coupling element multiple magnetic pins 96 which, in the intended assembled state, are “latched” in the likewise magnetic depressions 98. The intermediate modules 90 and 92 have—for intermediate coupling—on their two coupling surfaces on the one hand the magnetic depressions 98 and on the other hand the magnetic pins 96.

The intermediate module 92 is used in the present exemplary embodiment as a sensor carrier and has here a pressure sensor 100. An assigned sensor bore hole extends here as far as into the fluid channel 30.

In the present exemplary embodiment, the intermediate module 90 forms an insertion module for a static mixing unit 102 and has for this purpose an insertion shaft 104. The fluid channel 30 issues into this insertion shaft 104 and also re-emerges from it. The sheathed line 34 is guided here around the insertion shaft 104.

The subject of the invention is not limited to the exemplary embodiments described above. On the contrary, further embodiments of the invention can be derived by the person skilled in the art from the description above. In particular, the individual features of the invention, which are described with the aid of the exemplary embodiments, and their variants of the embodiments can also be combined with one another in other ways.

### LIST OF REFERENCE NUMERALS

1 3D Printing system
2 Cartridge container
4 Cartridge container
6 Cartridge
8 Cartridge
10 Print head
12 Outflow opening
14 Fluid line
16 Fluid line
20 Temperature control channel
20a Container section
20b Line section
20c Head section
22 Temperature control channel
22a Container section
22b Line section
22c Head section
30 Fluid channel
32 Fluid channel
34 Sheathed line
36 Diversion channel
36a Diversion channel
38 Return pipe
38a Return pipe
40 Inflow
41 Peltier element
41a Housing
41b Fan
42 Peltier element
43 Collar
44 Nozzle
46 Hose connector
48 Outer wall
50 Connection opening
52 Hose
54 Opening
56 Flat side
58a Positioning nipple
58b Positioning depression
58c Flank
58d Flank
58e Retaining magnet
60 Fluid line
62 Temperature control channel
62b Line section
70 Print nozzle
72 Nozzle channel
73 Connection surface
74 Contact
76 Heating element
78 Pin
80 Bore hole
82 Groove
84 Circular line segment
86 Sensor bore hole
88 Optical window
90 Intermediate module
92 Intermediate module
94 Temperature sensor
96 Magnetic pin
98 Magnetic depression
100 Print sensor
102 Static mixing unit
104 Insertion shaft

1-21. (canceled)

22. A 3D printing system, comprising:
a first cartridge container for reversibly receiving a first cartridge storing printing fluid for a 3D print, said first cartridge container having an outside;
a print head with an outflow opening;
a first fluid line connecting said first cartridge container to said print head for supplying printing fluid to said print head;
a first temperature control channel encasing said outside of said first cartridge container, said first temperature control channel being guided at least along said first fluid line and, in an intended application state, said first temperature control channel guiding a temperature control medium through said first temperature control channel; and
a first return line guided at least in a region of said first fluid line coaxially relative to said first temperature control channel;
said first temperature control channel having a print head side merging into said first return line.

23. The 3D printing system according to claim 22, wherein said first fluid line has an outside encased by said first temperature control channel.

24. The 3D printing system according to claim 22, wherein said print head has a first fluid channel for the printing fluid, and said first temperature control channel continues into said print head and is guided along said first fluid channel or encases an outside of said first fluid channel at least in sections.

25. The 3D printing system according to claim 22, which further comprises a second cartridge container, a second fluid line and a second temperature control channel, said first and second fluid lines being brought together in said print head at said outflow opening.

26. The 3D printing system according to claim 22, wherein said print head has at least one of an additional supply for the temperature control medium or an additional heating element or an additional cooling element.

27. The 3D printing system according to claim 22, which further comprises a print nozzle having a nozzle channel for the printing fluid, said print nozzle being reversibly connected to said outflow opening, or said nozzle being reversibly connected to said outflow opening and said nozzle channel being enclosed at least in sections coaxially by a channel for the temperature control medium.

28. The 3D printing system according to claim 27, wherein said print nozzle has a closing valve for said nozzle channel.

29. The 3D printing system according to claim 27, which further comprises at least one additional module connected or configured to be connected between said print nozzle and said print head, said at least one additional module forming a carrier for at least one of at least one sensor, or at least one of a heating or cooling element, or a mixing unit or a microfluidic chip.

30. The 3D printing system according to claim 22, which further comprises a valve configured to vary a through-flow between a section of said first or second temperature control channel surrounding said first or second cartridge container and a section surrounding said first or second fluid line.

31. The 3D printing system according to claim 22, wherein said first or second fluid line and a section of said first or second temperature control channel associated with said first or second fluid line are flexibly constructed.

32. The 3D printing system according to claim 22, which further comprises at least one optical window disposed upstream of said outflow opening for exposing the printing fluid to radiation through said at least one optical window.

33. The 3D printing system according to claim 22, which further comprises at least one optical window in said print nozzle for exposing the printing fluid to radiation through said at least one optical window.

34. The 3D printing system according to claim 22, wherein:
said first cartridge container is one of a number of first cartridge containers;
said print head is one of a number of print heads corresponding to said number of first cartridge containers;
said first fluid line is one of a number of first fluid lines each connecting a respective print head to a respective first cartridge container;
said first temperature control channel is one of a number of first temperature control channels each associated with a respective one of said first fluid lines; and
diametrically opposed couplings are disposed on two opposite sides of said print heads, for coupling a plurality of said print heads to one another in series.

35. The 3D printing system according to claim 22, which further comprises a controller, and at least one pressure sensor connected to said controller, said at least one pressure sensor, in the intended application state, being in contact with the printing fluid.

36. The 3D printing system comprising:
a first cartridge container for reversibly receiving a first cartridge storing printing fluid for a 3D print, said first cartridge container having an outside;
a print head with an outflow opening;
a first fluid line connecting said first cartridge container to said print head for supplying printing fluid to said print head; and
a first temperature control channel encasing said outside of said first cartridge container, said first temperature control channel being guided at least along said first fluid line and, in an intended application state, said first temperature control channel guiding a temperature control medium through said first temperature control channel;
a print nozzle reversibly connected to said outflow opening; and
at least one additional module connected or configured to be connected between said print nozzle and said print head, said at least one additional module forming a carrier for at least one of at least one sensor, or at least one of a heating or cooling element, or a mixing unit or a microfluidic chip.

37. The 3D printing system according to claim 36, which further comprises a first return line guided at least in a region of said first fluid line coaxially relative to said first temperature control channel, said first temperature control channel having a print head side merging into said first return line.

38. The 3D printing system according to claim 37, which further comprises a return pipe guided at least in the region of said first fluid line separately from said first fluid line, said first temperature control channel having a print head side merging into said return pipe.

39. A 3D printing system comprising:
a first cartridge container for reversibly receiving a first cartridge storing printing fluid for a 3D print, said first cartridge container having an outside;
a print head with an outflow opening;
a first fluid line connecting said first cartridge container to said print head for supplying printing fluid to said print head; and
a first temperature control channel encasing said outside of said first cartridge container and having a section, said first temperature control channel being guided at least along said first fluid line and, in an intended application state, said first temperature control channel guiding a temperature control medium through said first temperature control channel;
said first fluid line and said section of said first temperature control channel being flexibly constructed.

40. The 3D printing system according to claim 39, which further comprises a first return line guided at least in a region of said first fluid line coaxially relative to said first temperature control channel, said first temperature control channel having a print head side merging into said first return line.

41. The 3D printing system according to claim 39, which further comprises a nozzle channel for the printing fluid, said nozzle channel being reversible, or said nozzle channel being reversible and enclosed at least in sections coaxially by a channel for the temperature control medium.
